(19) United States
(12) Patent Application Publication
(10) Pub. No.: US 2009/0047497 A1
(43) Pub. Date: Feb. 19, 2009

(54) GRASS (HERBACEOUS PLANT) FIBER

(76) Inventor: Chan-Oh Park, Bukjeju-Gun Jeju-Do (KR)

Correspondence Address: IPLA P.A., 3580 WILSHIRE BLVD., 17TH FLOOR, LOS ANGELES, CA, 90010, US

(21) Appl. No.: 12/282,644

(22) PCT Filed: Mar. 9, 2007
(86) PCT No.: PCT/KR2007/001164

§ 371 Date: Sep. 11, 2008

(30) Foreign Application Priority Data
Mar. 13, 2006 (KR) 10-2006-0022930
Jul. 5, 2006 (KR) 20-2006-0018154
Feb. 15, 2007 (KR) 10-2007-0015783

(51) Int. Cl. B32B 5/02; D21C 1/00; D21H 17/68; C04B 14/38

(52) U.S. Cl. 428/294.7; 162/57; 162/181.8; 106/803

(57) ABSTRACT

There are provided a method for manufacturing various products needed in an actual life which may be implemented in combination with a refiner for refining plants by a mechanical method, a method for refining plants, a molding mixture which is made by mixing refined fiber, clay and water and molds and dries as an interior decorative material for architecture, a heat keeping, adiabatic, sound proof, fireproof board, brick and block, a decorative design (cement mortar) mixture, a fiber having an enhanced tensional force, a cement board which has an architecture interior and exterior heat keeping, adiabatic, soundproof, fireproof functions manufactured by mixing cement and water, a cement material, a fiber board manufactured by mixing fiber and adhesive material, paper made of fiber, thread woven with fiber, and a fiber heat keeping material made of fiber.

### TECHNICAL FIELD

The present invention relates to a plant (herbaceous) fiber, and in particular to a method for manufacturing various products needed in an actual life which may be implemented in combination with a refiner for refining plants by a mechanical method, a method for refining plants, a molding mixture which is made by mixing refined fiber, clay and water and molds and dries as an interior decorative material for architecture, a heat keeping, adiabatic, sound proof, fireproof board, brick and block, a decorative design (cement mortar) mixture, a fiber having an enhanced tensional force, a cement board which has an architecture interior and exterior heat keeping, adiabatic, soundproof, fireproof functions manufactured by mixing cement and water, a cement material, a fiber board manufactured by mixing fiber and adhesive material, paper made of fiber, thread woven with fiber, and a fiber heat keeping material made of fiber.

### BACKGROUND ART

Various refining methods of plant (herbaceous plants) are being developed. However, a chemical refining method may cause environment problems. A mechanical refining method has a limited application range because the length of refined fiber is short.

### DISCLOSURE OF INVENTION

Accordingly, it is an object of the present invention to overcome the above problems.

It is another object of the present invention to provide a plant fiber which is able to simply refine plants by developing a refiner that separates longer fibers. An architecture interior and exterior heat keeping, adiabatic, soundproof and fireproof board is manufactured by mixing a refined fiber with clay and water or mixing cement and water, which may exchange asbestos, Styrofoam, etc. A fiber board is manufactured by making paper with plant fiber for thereby exchanging a wooden pulp. Threads are manufactured with plant fibers without using cotton fiber. A glass fiber may be made by compressing fibers.

It is further another object of the present invention to provide various methods in which a refiner manufacturing method is able to mechanically refine plants (herbaceous plants), and a method is able to refine with longer fibers, a mixing method is provided for manufacturing an architecture interior and exterior heat keeping, adiabatic, soundproof, fireproof board, brick, block and decorative (instead of using cement mortar) mixture, and molding mixture by mixing clay and water with refined fiber (3˜5 cm), and a method is disclosed for enhancing a tensional force of fiber, and a mixing method is disclosed, which is able to manufacturing an architecture interior and exterior cement board and a cement material by mixing cement and water with fiber, and a certain mixing ratio is disclosed, and a method is disclosed for manufacturing an architecture interior and exterior material, and a method is disclosed for manufacturing a fiber board by mixing fiber and adhesive, and a method is developed for manufacturing paper with fiber, and a method is disclosed for manufacturing threads with fiber, and a method is disclosed for manufacturing a fiber heat keeping material using fiber.

### BEST MODE FOR CARRYING OUT THE INVENTION

1. Method for Manufacturing Plant (Herbaceous) Refiner

It is implemented using a common home mixer. A blade of each rotation wing is made edgeless, so that the rotation wings do not cut the plants, thus impacting the same in the course of rotation (10000˜16000 revolutions per minute, whereby the fibers are separated in water.

A. Thickness of Rotation Wing

The thickness of the rotation wing is preferably 0.1˜5 cm, and the thickness of 0.1˜0.5 cm is for the plants with lengths of 1˜5 cm, and the thickness of 0.6˜5 cm is for the plant having a thick outer skin or the plant of 6˜20 cm length.

B. Length of Rotation Wing

The total length of the rotation wing is above 8 cm for properly refining plants. The length of the same is determined depending on the kind of plant to be refined, the length of plant, the amount of plant, the thickness of the rotation wing, and the capacity of the motor.

C. Rotation Speed of Rotation Wing

The rotation speed of 10000˜160000 revolutions per minute is a reference speed when the thickness of the rotation wing is 0.1˜0.5 cm, and the total length of the rotation wing is 8 cm. When the rotation wing having a certain length is manufactured and used, the rotation speed of the rotation wing is determined depending on the impacting power based on the reference rotation speed.

2. Method for Refining Plant (Herbaceous)

All kinds of plants can be refined and used as fibers. However, plants such as rice straw, wild plant, lawn having long leaves are easy to refine.

A. Method 1 for Refining

1) When grown up plants are cut and dried.

2) Plants are cut with certain sizes.

3) Cut plants are submerged in water and swelled.

4) Swollen plants are mixed with water in the refiner at a ratio of plants of below 10% and water of above 90% and are mixed for 0.5˜3 min, so that it is possible to obtain desired length fibers. (After refining process, Lig.nin is ground, and the length of fibers are long, so that thereby are easy to separate from each other, and Lig.nin does not remain in the plants.

5) Fibers are washed with water and are dried.

B. Method 2 for Refining

1) Grown up plants are cut and dried.

2) Plants are cut with certain sizes (to be used).

3) The cut plants are submerged in water and fermented for 3˜7 days at temperature below 40° C.

4) The fermented plants are mixed with plants of below 10% and water of above 90% in the refiner and are processed for 0.5˜3 min for thereby obtaining a fiber having a desired length. (The amount of grinding fiber is less in the course of refining, and reining work is fastest, and Lig.nin does not remain in the plants).

5) The fiber is washed with water and is dried.

C. Method 3 for Refining

1) The grown up plants are cut and dried.

2) Uncut plants are swelled in water.

3) Some plants are grouped, and the lower ends of the same are tied with thickness of 1˜3 cm for thereby forming groups.

4) A rubber board is prepared on the floor, and the tied plants are arranged horizontally, and holding the tired portions of the plants, the plants are hit at the floor or the circular column. The above process is repeated for thereby refining the fibers of 10˜30 cm. (Lig.nin does not remain in the plants).

5) The refined fibers are washed with water, and the tired portion of a diameter of 1˜3 cm is cut with knife and is dried.

D. Method 4 for Refining

1). The grown up plants are cut and dried.

2) The uncut plants are submerged in water and are fermented at 40° C. for 3˜7 days.

3) The fermented plants are grouped, and the lower ends of the same (cut portions) are tied with a diameter of 1˜3 cm for thereby forming the grouped plants.

4) The rubber board is prepared on the floor, and the tied plants are arranged horizontally thereon, and the plants are pressurized with both hands and are rubbed repeatedly. Holding the tired portions of the plants, the plants are repeatedly hit by the floor or the circular column for thereby refining the fibers of 10˜30 cm. (A little amount of Lig.nin remains in the plants after refining).

5) The refined fibers are washed with water, and the tied portions of a diameter of 1˜3 cm are cut with a knife, and the fibers are dried.

3. Method for Mixing Plants (Herbaceous) Fiber, Clay, and Water

A. Method for Mixing Molding Mixture

1) Clay and water are mixed first (20˜30% of the amount of water corresponds to the total volume (summed with fiber, clay, water) is to mix, but a preferably less amount of water has a high tensional force after molding and drying).

2) Well mixed clay and water is slowly stirred and refined. The dried fibers (3˜5 cm) are arranged thinner and added by small amount so that the fibers are not entangled with each other by well stirring the same. (As the well mixed clay water can well penetrate into the gaps of dried fibers, so that it has the highest tensional force after the drying process).

B. Method for Concurrently Molding and Mixing

1). Clay and water are mixed first.

2) The well mixed clay water is sprayed with paper being arranged on the molding board.

3) The refined and dried fibers (3˜5 cm) are arranged on the sprayed clay water thinner.

4) The clay water is sprayed on the fibers.

5) The above procedure is repeated, so that the thickness is adjusted, and the clay water is sprayed at the final stage.

4. Mixing Ratio of Plants (Herbaceous), Clay and Water and Method for Manufacturing Architecture Interior Material

A. The mixing ratios of the fiber and clay with respect to the volume L are (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2, (20) 1:2.1, (21) 1:2.2, (22) 1:2.3, (23) 1:2.4, (24) 1:2.5, (25) 1:2.6, (26) 1:2.7, (27) 1:2.8, (28) 1:2.9, (29) 1:3, (30) 1:3.1, (31) 1:3.2, (32) 1:3.3, (33) 1:3.4, (34) 1:3.5, (35) 1:3.6, (36) 1:3.7, (37) 1:3.8, (38) 1:3.9, (39) 1:4, (40) 1:4.1, (41) 1:4.2, (42) 1:4.3, (43) 1:4.4, (44) 1:4.5, (45) 1:4.6, (46) 1:4.7, (47) 1:4.8, (48) 1:4.9, (49)1:5. With the above ratios, it is possible to obtain a tensional force when manufacturing an architecture interior decoration heat keeping, adiabatic and soundproof, fireproof board and bricks, and blocks. (The volume of the fibers is determined with reference to the volume out of the fibers measured by applying pressure to the measuring container which is able to measure the volume. The actual volume of fiber is about 35% except for the space volume 65% between the space in the fibers and the space between fibers.

B. The water is about 20%˜30% of the total volume (summed volume of fiber, clay and water), a preferably less amount of water substantial for mixing and molding is preferred for a high tensional strength for molding and dry.

C. The mixing ratios between the fiber and clay are 49 from (1) 1:0.2 to (49) 1:5. Water is 20˜30% of the total volume, and when mixing at the mixing method of molding mixture, it is possible to manufacture heat keeping, adiabatic, soundproof, fireproof board and brick and block, so that the molding mixture can be differently manufactured at 49 ratios, respectively.

1) According to the mixing ratios of (1)1:0.2-(7)1:0.8 among the above mixing ratios of the molding mixture, when the fibers are more, the tensional strength decreases after the processes of plate shape and dry, and the weight decrease. It is possible to manufacture an architecture interior heat keeping, adiabatic and soundproof board. In case of the fiber having most fibers of (1)1:0.2, clay water penetrates into the fibers, so that it does not well burn in case of fire.

2) According to the mixing ratios of (12)1:1.3-(49)1:5 among the above mixing ratios of the molding mixture, when the clay is more than fibers, the weight increases, and the tensional strength decreases. It may be manufactured for the purpose of fireproof. It may have an enough effect for preventing the fire from spreading at the first stage of fire.

3) According to the mixing ratios of (1)1:0.2-(49)1:5 among the above mixing ratios of the molding mixture, the above ratio is proper for the use of a heat keeping, adiabatic, soundproof, fireproof block and block.

D. Among the mixing ratios of the fiber and the clay, the ratio of (8)1:0.9˜(49)1:5, the water occupies 30˜40% of the total volume, and the length of the fiber is 1˜2 cm for thereby mixing a mixture. The above mixture is proper for a heat keeping, adiabatic, soundproof, fireproof and decorative (for the use of cement mortar).

E. The mixed mixture (except for the mixture of decoration) is provided with a molding and mechanical pressure with paper being disposed on the molding board.

F. The mixture is cut and polished after dry.

G. The size of the board is 90 cm in a horizontal side and 180 cm in a vertical side (thickness). When the height (thickness) of the board is above 1 cm, it is possible to increase the board more.

H. The sizes of the bricks or blocks may change depending on the purpose of the use.

5. Method for Increasing Tensional Force of Plant (Herbaceous) Fiber

The fibers refined using a refiner are submerged in boiling water and boiled for 1˜2 min and are dried, so that it is possible to enhance the tensional force of the fiber.

6. The method for mixing plant (herbaceous) fiber, cement and water is the same as the method of mixing a plant (herbaceous) fiber, clay and water of the above 3. (In this case, cement is used instead of clay).

7. A mixing ratio of a plant (herbaceous) fiber, cement and water and a method for manufacturing an architecture interior and exterior material.

A. The mixing ratios of the fiber and clay with respect to the volume L are (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2, (20) 1:2.1. With the above ratios, it is possible to obtain a tensional force when manufacturing an architecture interior and exterior decoration heat keeping, adiabatic and soundproof, fireproof board and rectangular timber. (The volume of the fibers is determined with reference to the volume out of the fibers measured by applying pressure to the measuring container which is able to measure the volume. The actual volume of fiber is about 35% except for the space volume 65% between the space in the fibers and the space between fibers.

B. The water is about 20%-30% of the total volume (summed volume of fiber, clay and water), a preferably less amount of water substantial for mixing and molding is preferred for a high tensional strength for molding and dry.

C. According to the mixing ratios of (1)1:0.2-(4)1:0.5 among the above mixing ratios of the fiber and the cement, when the fibers are more, the tensional strength decreases after the processes of molding, dry and plate shape, and the weight decrease. It is possible to manufacture an architecture interior and exterior heat keeping, adiabatic and soundproof board. In case of the fiber having most fibers of (1)1:0.2, cement water penetrates into the fibers, so that it does not well burn in case of fire.

D. According to the mixing ratios of (7)1:0.8-(19)1:2 among the above mixing ratios of the fiber and cement, it is possible to manufacture an architecture interior and exterior heat keeping, adiabatic, soundproof and fireproof board and rectangular timber.

E. The mixing is performed at the above mixing ratio, and paper is arranged on the molding board, and it is mechanically pressurized after the molding, and then is dried.

F. It is cut and polished after dry.

G. The size of the board is 90 cm in a horizontal side and 180 cm, and the height (thickness) is 0.5 cm˜10 cm and is used. When the thickness of the board is above 1 cm, a wider board may be manufactured and used.

8. A Mixing Ratio of Plant (Herbaceous) Fiber and a Method for Manufacturing Board

A. A refiner is used for refining, and dried fiber fiber weight percent ratio (g) 90%˜95%:A mixing ratio of weight percent ratio (g) of 5%˜10% of urea-formaldehyde resin adhesive or urea-formaldehyde & melamine resin is used.

B. The fibers refined with lengths of 3˜5 cm using a refiner are moved at high speed using a molding machine via a pipeline in the drier, and adhesive is sprayed via the nozzles attached to the pipe, and it is coated. At this time, a high pressure vapor is sprayed for thereby forming turbulent flow, and the fibers are forced to rotate for thereby obtaining a uniform coating.

C. The thickness is determined, and the layers are stacked.

D. A mechanical pressure is applied for 20˜30 seconds at 160˜180° C., and the fiber board is manufactured.

E. It is disposed at below 70° C., and is dried and cu and polished.

9. Method for Manufacturing Paper Using Plant (Herbaceous) Plant

A. The fibers having 3˜5 cm in length and refined with a refiner are submerged in alkali solution and are boiled for 1˜2 hours (until concentration is maintained so that foams do not flow over the container when boiling the alkali solution), and the organic materials such as Lig.nin, starch and sugar are removed from the fibers, so that the fibers are made softer.

B. Water is sprayed on fibers, and the fibers are smashed or ground for manufacturing a source material proper for manufacturing paper.

C. The fiber of 10%, adhesive of 15˜20% and water of 70˜75% are mixed.

D. The paste fibers and water are well stirred in one direction, and adhesive (PAM: Polyacrylamide, PEO: polyethylene oxide, etc.) are added, and the mixture is well stirred so that the fibers have constant concentration.

E. Paper is finished via a paper netting work, dehydration, compression and dry processes.

10. Method for Manufacturing Plant (Herbaceous) Fiber

A. Stem of the plant (herbaceous) is removed so as to use the fibers having constant thickness, and only leaves are separated and cut with lengths of 3˜5 cm and are swelled in water or are submerged and fermented in water for 3˜7 days at about 40° C., and water of above 90% and leaves of below 10% are inputted into the refiner, and the refiner operates for 0.5-3 minutes for thereby refining the leaves.

B. The refined leaves are submerged in water for thereby removing Lig.nin, and only fibers are obtained. Lig.nin is ground, and the fibers are long, so that it is possible to easily separate the fibers.

C. The fibers are submerged in alkali solution and are boiled for 10˜20 minutes until the concentration at which foams do not flow over the container is maintained when boiling in alkali solution, so that the fibers are made softer.

D. The fibers are washed with water and are dried.

E. The fibers are processed via browing, carding, drawing, roving, spinning processes.

11. Method for Manufacturing Heat Keeping Material Using Plant (Herbaceous) Fibers

A. The fibers of lengths of 3˜5 cm refined with the refiner are submerged in alkali solution and are boiled for 1˜5 minutes until the foams do not flow over the container when it is boiled in alkali solution.

B. The fibers are well washer with clean water.

C. The amount of fiber is determined depending on the thickness of the heat keeping material, which will be manufactured, and is poured onto a molding plate in water-soaked state, and pressure is mechanically applied.

D. The fibers are dried and cut.

### INDUSTRIAL APPLICABILITY

As described above, in the present invention, it is possible to mix the mechanically refined fibers with other materials and to use for various purposes. The products according to the present invention have the following advantages.

1. Manufacturing Effects of Refiner

A. It is possible to easily manufacture longer fibers by refining plant (herbaceous).

B. As a refining time period may change depending on the kinds of plant (herbaceous), a desired length can be determined and refined.

C. The ground organic material such as Lig.nin, starch, sugar, etc. may be used to feed animal or may be fermented for thereby making alcohol or may be decayed for fertilizer.

2. Effects of Clay Board

A. Since heat conductivity is low, in winter and summer, external hot and cool airs are disconnected for thereby increasing heat efficiency, so that the indoor temperature can be easily controlled.

B. When the amount of the clay is more than fiber, it can be used for manufacturing a fireproof board since it has an initial fire combustion delay effect.

C. Since it is made of a combined material of fiber and clay, the product has better heat keeping, adiabatic, soundproof and fireproof functions as compared to other materials.

D. No contraction and extension are found with respect to changing temperature and moisture, so that distortion and gaps are not formed after construction.

E. It can be easily cut using knife or sew and can be easily attached using nail, screw, tacker nail, etc.

F. Construction is easy, and construction period can be decreased, and material cost can be reduced by using natural materials.

G. The product of the present invention may be used instead of a plaster board, asbestos, rock surface, glass fiber, Styrofoam, etc. When there are discarded, 100% recycle is possible.

3. Effects of Cement Board

A. It is a combined material of fiber and cement and has a reliable property with respect to moisture and fire, and it can be used for a semi-permanent material instead of wooden veneer or rectangular timber for an architecture interior or exterior material.

B. It can be easily cut with a blade being attached at a grinder used for cutting rocks, and it can be easily attached with nail, screw, tacker nail, etc.

C. After a board construction is finished, a waterproof, tile, decorative work is possible.

4. Effects of Plant (Herbaceous) Fiber Board

It can be manufactured in various desired shapes such as fiber board, rectangular timber, curved board. It can be used for an architecture interior board, rectangular timber, furniture material and rectangular timber.

5. Effects of Paper Made of Plant (Herbaceous) Fiber

The plants (herbaceous), which are easily obtained from the nature, can be simply refined without a chemical process, so that Lig.nin can be easily separated from fibers, whereby the nature state is not damaged for thereby manufacturing paper. Without using the wooden, it is possible to protect the nature.

6. Effects after Spinning Plant (Herbaceous) Fiber

Plants (herbaceous), which can be easily obtained from the nature, are refined for thereby spinning fibers. It can be used instead of cotton fiber, and mass production is possible.

7. Effects of Plant (Herbaceous) Fiber Heat Keeping Material

It can be used instead of glass fiber or Styrofoam and can be used at a curved portion like a pipe. It is an environment-friendly product and has an excellent heat keeping effect, adiabatic and soundproof effect.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1-2. (canceled)

3. A method for refining comprising:
a step in which grown up plants are cut and dried;
a step in which the plants are cut with proper lengths and are swelled in water; and
a step in which plants of below 10% and water of above 90% are mixed and processed for 0.5˜3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000˜16000 revolutions per min (thickness of rotation wing is 0.1˜0.5 cm, and the total length of the rotation wing is 8 cm), and with the above construction, fibers are separated in water, and the thickness 0.1˜0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor.

4. A plant (herbaceous) fiber which is made in such a manner that grown up plants are cut and dried; and the plants are cut with proper lengths and are swelled in water; and plants of below 10% and water of above 90% are mixed and processed for 0.5˜3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000-16000 revolutions per min (thickness of rotation wing is 0.1˜0.5 cm, and the total length of the rotation wing is 8 cm), and with the above construction, fibers are separated in water, and the thickness 0.1˜0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor.

5. A method for refining a fiber, comprising:
a step in which grown up plants (herbaceous) are cut and dried;
a step in which the dried plants are cut with proper lengths to be used;
a step in which the plants are submerged in water at 40° C. and are fermented therein for 3˜7 days;
a step in which plants of below 10% and water of above 90% are mixed and processed for 0.5˜3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000-16000 revolutions per min (thickness of rotation wing is 0.1˜0.5 cm, and the total length of the rotation wing is 8 cm), and with the above construction, fibers are separated in water, and the thickness 0.1-0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor.

6-13. (canceled)

14. A molding mixing ratio of 49 ratios mixed with fiber, clay and water characterized in that grown up plants (herbaceous) are cut and dried; and the dried plants are cut with proper lengths to be used; and the plants are submerged in water at 40° C. and are fermented therein for 3˜7 days; and plants of below 10% and water of above 90% are mixed and processed for 0.5˜3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000˜16000 revolutions per min (thickness of rotation wing is 0.1˜0.5 cm, and the total length of the rotation wing is 8 cm), and with the above construction, fibers are separated in water, and the thickness 0.1-0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor, and wherein the thusly processed fibers are applied with a certain pressure in a measuring container of which volume can be measured, so that the mixing ratio of fiber and clay with respect to the volume L is (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2, (20) 1:2.1, (21) 1:2.2, (22) 1:2.3, (23) 1:2.4, (24) 1:2.5, (25) 1:2.6, (26) 1:2.7, (27) 1:2.8, (28) 1:2.9, (29) 1:3, (30) 1:3.1, (31) 1:3.2, (32) 1:3.3, (33) 1:3.4, (34) 1:3.5, (35) 1:3.6, (36) 1:3.7, (37) 1:3.8, (38) 1:3.9, (39) 1:4, (40) 1:4.1, (41) 1:4.2, (42) 1:4.3, (43) 1:4.4, (44) 1:4.5, (45) 1:4.6, (46) 1:4.7, (47) 1:4.8, (48) 1:4.9, (49)1:5, and water is mixed with 20˜30% of the total volume, and for a proper use of the same, clay and water are first mixed at the above ratios, and the well mixed clay and water are slowly stirred, and the dried fiber of 3˜5 cm long are spread thinner at 49 ratios, respectively, and the fibers are prevented from entangled with each other, so that after molding, board shape and dry processes are performed, it is possible to manufacture an architecture interior heat keeping, adiabatic, soundproof, fireproof board and bricks and blocks having a proper tensional force.

15. A molding, board shape, compression, dry, cutting-processed architecture heat keeping, adiabatic and soundproof board characterized in that grown up plants (herbaceous) are cut and dried; and the dried plants are cut with proper lengths to be used; and the plants are submerged in water at 40° C. and are fermented therein for 3-7 days; and plants of below 10% and water of above 90% are mixed and processed for 0.5-3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000-16000 revolutions per min (thickness of rotation wing is 0.1-0.5 cm, and the total length of the rotation wing is 8 cm), and with the above construction, fibers are separated in water, and the thickness 0.1-0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor, and wherein the thusly processed fibers are applied with a certain pressure in a measuring container of which volume can be measured, so that the mixing ratio of fiber and clay with respect to the volume L is (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2, (20) 1:2.1, (21) 1:2.2, (22) 1:2.3, (23) 1:2.4, (24) 1:2.5, (25) 1:2.6, (26) 1:2.7, (27) 1:2.8, (28) 1:2.9, (29) 1:3, (30) 1:3.1, (31) 1:3.2, (32) 1:3.3, (33) 1:3.4, (34) 1:3.5, (35) 1:3.6, (36) 1:3.7, (37) 1:3.8, (38) 1:3.9, (39) 1:4, (40) 1:4.1, (41) 1:4.2, (42) 1:4.3, (43) 1:4.4, (44) 1:4.5, (45) 1:4.6, (46) 1:4.7, (47) 1:4.8, (48) 1:4.9, (49)1:5, and water is mixed with 20-30% of the total volume, and for a proper use of the same, clay and water are first mixed at the above ratios, and the well mixed clay and water are slowly stirred, and the dried fiber of 3˜5 cm long are spread thinner at 49 ratios, respectively, and the fibers are prevented from entangled with each other, and the molding board, board shape, compression, dry and cutting-processed architecture interior decorative heat keeping and adiabatic and soundproof board are manufactured using (1)1:0.2˜(7)1:0.8 ratios among the above ratios with a tensional force being provided for manufacturing an architecture interior keeping, adiabatic, soundproof, fireproof board and bricks and blocks.

16. A molding, board shape, compression, dry, cutting-processed architecture heat keeping, adiabatic and soundproof board characterized in that grown up plants (herbaceous) are cut and dried; and the dried plants are cut with proper lengths to be used; and the plants are submerged in water at 40° C. and are fermented therein for 3-7 days; and plants of below 10% and water of above 90% are mixed and processed for 0.5-3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000-16000 revolutions per min (thickness of rotation wing is 0.1-0.5 cm, and the total length of the rotation wing is 8 cm), and with the above construction, fibers are separated in water, and the thickness 0.1-0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor, and wherein the thusly processed fibers are applied with a certain pressure in a measuring container of which volume can be measured, so that the mixing ratio of fiber and clay with respect to the volume L is (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2, (20) 1:2.1, (21) 1:2.2, (22) 1:2.3, (23) 1:2.4, (24) 1:2.5, (25) 1:2.6, (26) 1:2.7, (27) 1:2.8, (28) 1:2.9, (29) 1:3, (30) 1:3.1, (31) 1:3.2, (32) 1:3.3, (33) 1:3.4, (34) 1:3.5, (35) 1:3.6, (36) 1:3.7, (37) 1:3.8, (38) 1:3.9, (39) 1:4, (40) 1:4.1, (41) 1:4.2, (42) 1:4.3, (43) 1:4.4, (44) 1:4.5, (45) 1:4.6, (46) 1:4.7, (47) 1:4.8, (48) 1:4.9, (49)1:5, and water is mixed with 20-30% of the total volume, and for a proper use of the same, clay and water are first mixed at the above ratios, and the well mixed clay and water are slowly stirred, and the dried fiber of 3˜5 cm long are spread thinner at 49 ratios, respectively, and the fibers are prevented from entangled with each other, and the molding board, board shape, compression, dry and cutting-processed architecture interior decorative heat keeping and adiabatic and soundproof board are manufactured using (8)1:0.9˜(11)1:1.2 ratios among the above ratios with a tensional force being provided for manufacturing an architecture interior keeping, adiabatic, soundproof, fireproof board and bricks and blocks.

17. A molding, board shape, compression, dry, cutting and polishing-processed, architecture interior decorative fireproof dedicated board characterized in that grown up plants (herbaceous) are cut and dried; and the dried plants are cut with proper lengths to be used; and the plants are submerged in water at 40° C. and are fermented therein for 3-7 days; and plants of below 10% and water of above 90% are mixed and processed for 0.5˜3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000˜16000 revolutions per min (thickness of rotation wing is 0.1˜0.5 cm, and the total length of the rotation wing is 8 cm), and with the above construction, fibers are separated in water, and the thickness 0.1˜0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor, and wherein the thusly processed fibers are applied with a certain pressure in a measuring container of which volume can be measured, so that the mixing ratio of fiber and clay with respect to the volume L is (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2, (20) 1:2.1, (21) 1:2.2, (22) 1:2.3, (23) 1:2.4, (24) 1:2.5, (25) 1:2.6, (26) 1:2.7, (27) 1:2.8, (28) 1:2.9, (29) 1:3, (30) 1:3.1, (31) 1:3.2, (32) 1:3.3, (33) 1:3.4, (34) 1:3.5, (35) 1:3.6, (36) 1:3.7, (37) 1:3.8, (38) 1:3.9, (39) 1:4, (40) 1:4.1, (41) 1:4.2, (42) 1:4.3, (43) 1:4.4, (44) 1:4.5, (45) 1:4.6, (46) 1:4.7, (47) 1:4.8, (48) 1:4.9, (49)1:5, and water is mixed with 20-30% of the total volume, and for a proper use of the same, clay and water are first mixed at the above ratios, and the well mixed clay and water are slowly stirred, and the dried fiber of 3˜5 cm long are spread thinner at 49 ratios, respectively, and the fibers are prevented from entangled with each other, and the molding board, board shape, compression, dry and cutting-processed architecture interior decorative heat keeping and adiabatic and soundproof board are manufactured using (11)1:1.3˜(49)1:5 ratios among the above ratios with a tensional force being provided for manufacturing an architecture interior keeping, adiabatic, soundproof, fireproof board and bricks and blocks.

18. A molding, compression, dry, polishing-processed architecture interior decorative heat keeping, adiabatic, soundproof, fireproof brick characterized in that grown up plants (herbaceous) are cut and dried; and the dried plants are cut with proper lengths to be used; and the plants are submerged in water at 40° C. and are fermented therein for 3-7 days; and plants of below 10% and water of above 90% are mixed and processed for 0.5-3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000˜16000 revolutions per min (thickness of rotation wing is 0.1˜0.5 cm, and the total length of the rotation wing is 8 cm), and with the above construction, fibers are separated in water, and the thickness 0.1˜0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor, and wherein the thusly processed fibers are applied with a certain pressure in a measuring container of which volume can be measured, so that the mixing ratio of fiber and clay with respect to the volume L is (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2, (20) 1:2.1, (21) 1:2.2, (22) 1:2.3, (23) 1:2.4, (24) 1:2.5, (25) 1:2.6, (26) 1:2.7, (27) 1:2.8, (28) 1:2.9, (29) 1:3, (30) 1:3.1, (31) 1:3.2, (32) 1:3.3, (33) 1:3.4, (34) 1:3.5, (35) 1:3.6, (36) 1:3.7, (37) 1:3.8, (38) 1:3.9, (39) 1:4, (40) 1:4.1, (41) 1:4.2, (42) 1:4.3, (43) 1:4.4, (44) 1:4.5, (45) 1:4.6, (46) 1:4.7, (47) 1:4.8, (48) 1:4.9, (49)1:5, and water is mixed with 20-30% of the total volume, and for a proper use of the same, clay and water are first mixed at the above ratios, and the well mixed clay and water are slowly stirred, and the dried fiber of 3˜5 cm long are spread thinner at 49 ratios, respectively, and the fibers are prevented from entangled with each other, and the molding board, board shape, compression, dry and cutting-processed architecture interior decorative heat keeping and adiabatic and soundproof board are manufactured using (1)1:0.2˜(49)1:5 ratios among the above ratios with a tensional force being provided for manufacturing an architecture interior keeping, adiabatic, soundproof, fireproof board and bricks and blocks.

19. (canceled)

20. An architecture interior decorative heat keeping, adiabatic, soundproof, fireproof decoration (instead of cement mortar) mixture characterized in that grown up plants (herbaceous) are cut and dried; and the dried plants are cut with proper lengths to be used; and the plants are submerged in water at 40° C. and are fermented therein for 3˜7 days; and plants of below 10% and water of above 90% are mixed and processed for 0.5˜3 minutes for thereby obtained fiber having desired lengths, wherein the refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000-16000 revolutions per min (thickness of rotation wing is 0.1˜0.5 cm, and the total length of the rotation wing is 8 cm), and with the above construction, fibers are separated in water, and the thickness 0.1-0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor, and wherein the thusly processed fibers are applied with a certain pressure in a measuring container of which volume can be measured, so that the mixing ratio of fiber and clay with respect to the volume L is (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2, (20) 1:2.1, (21) 1:2.2, (22) 1:2.3, (23) 1:2.4, (24) 1:2.5, (25) 1:2.6, (26) 1:2.7, (27) 1:2.8, (28) 1:2.9, (29) 1:3, (30) 1:3.1, (31) 1:3.2, (32) 1:3.3, (33) 1:3.4, (34) 1:3.5, (35) 1:3.6, (36) 1:3.7, (37) 1:3.8, (38) 1:3.9, (39) 1:4, (40) 1:4.1, (41) 1:4.2, (42) 1:4.3, (43) 1:4.4, (44) 1:4.5, (45) 1:4.6, (46) 1:4.7, (47) 1:4.8, (48) 1:4.9, (49)1:5, and water is mixed with 20-30% of the total volume, and for a proper use of the same, clay and water are first mixed at the above ratios, and the well mixed clay and water are slowly stirred, and the dried fiber of 3˜5 cm long are spread thinner at 49 ratios, respectively, and the fibers are prevented from entangled with each other, and the molding board, board shape, compression, dry and cutting-processed architecture interior decorative heat keeping and adiabatic and soundproof board are manufactured using (1)1:0.2˜(49)1:5 ratios among the above ratios with a tensional force being provided for manufacturing an architecture interior keeping, adiabatic, soundproof, fireproof board and bricks and blocks.

21-23. (canceled)

24. A molding, compression, dry, cutting and polishing-processed architecture interior and exterior decorative fireproof board in which water is provided at 20-30% with respect to the total volume, and (7)1:0.8˜(19)1:2 among the mixing ratio of fiber and cement having a tensional force proper for an architecture interior and exterior heat keeping, adiabatic, soundproof, fireproof board and a rectangular timber after a molding and drying process is used, and the cement and water are mixed at the above ratios, and the well mixed cement and water are slowly stirred, and the dried fiber of 3˜5 cm are spread thinner at the above ratios, and the fibers are prevented from entangled, wherein a refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000˜16000 revolutions per min (thickness of rotation wing is 0.1˜0.5 cm, and the total length of the rotation wing is 8 cm), and with the above construction, fibers are separated in water, and the thickness 0.1˜0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor, and wherein the thusly processed fibers are applied with a certain pressure in a measuring container of which volume can be measured, wherein the ratios of fiber and cement with respect to the volume L are (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2.

25. A molding, compression, dry, cutting-processed architecture interior and exterior decorative fireproof rectangular timber in which water is provided at 20-30% with respect to the total volume, and (7)1:0.8˜(19)1:1:2 among the mixing ratio of fiber and cement having a tensional force proper for an architecture interior and exterior heat keeping, adiabatic, soundproof, fireproof board and a rectangular timber after a molding and drying process is used, and the cement and water are mixed at the above ratios, and the well mixed cement and water are slowly stirred, and the dried fiber of 3˜5 cm are spread thinner at the above ratios, and the fibers are prevented from entangled, wherein a refiner is characterized in that it is manufactured with an application of a function of a common home mixer function by making a blade of a rotation wing blunt (rounded), and a rotation wing operates with a function of impacting a plant (herbaceous), not cutting the same, when it rotates at a high speed of 10000-16000 revolutions per min (thickness of rotation wing is 0.1˜0.5 cm, and the total length of the rotation wing is 8 cm), and with the above construction, fibers are separated in water, and the thickness 0.1˜0.5 cm of the rotation wing is proper for refining the plants of 1˜5 cm long, and the thickness 0.6˜5 cm of the rotation wing is proper for refining the plants having relatively hard outer skin and is proper for refining the plants of 6˜20 cm long, and the rotation wing having 8 cm long is proper for refining plants, and when the total length of the rotation wing is above 8 cm, the rotation speed is adjusted based on the impacting force of a reference rotation speed, and the length, which will be used, is determined depending on the kind of the plant to be refined, the length of the plant to be refined, the amount of the plant to be refined, the thickness of the rotation wing, and the capacity of the motor, and wherein the thusly processed fibers are applied with a certain pressure in a measuring container of which volume can be measured, wherein the ratios of fiber and cement with respect to the volume L are (1)1:0.2, (2)1:0.3, (3) 1:0.4, (4) 1:0.5, (5) 1:0.6, (6) 1:0.7, (7) 1:0.8, (8) 1:0.9, (9) 1:1, (10) 1:1.1, (11) 1:1.2, (12) 1:1.3, (13) 1:1.4, (14) 1:1.5, (15) 1:1.6, (16) 1:1.7, (17) 1:1.8, (18) 1:1.9, (19) 1:2.

26-33. (canceled)
